(19) United States
(12) Patent Application Publication
(10) Pub. No.: US 2020/0070994 A1
(43) Pub. Date: Mar. 5, 2020

(54) Engine Exhaust Suppressor

(71) Applicant: Bell Helicopter Textron Inc., Fort Worth, TX (US)

(72) Inventors: Angel D. Rosado, Aledo, TX (US); William Gons, Dallas, TX (US)

(73) Assignee: Bell Helicopter Textron Inc., Fort Worth, TX (US)

(21) Appl. No.: 16/117,840

(22) Filed: Aug. 30, 2018

(51) Int. Cl. B64D 33/04; F01D 25/30; B64D 33/08; B64C 29/00; B01F 3/02; B01F 5/00

(52) U.S. Cl. CPC B64D 33/04; F01D 25/30; B64D 33/08; F05D 2220/329; B01F 3/026; B01F 5/0057; B64C 29/0033

(57) ABSTRACT

Embodiments are directed to systems and methods for reducing the infrared signature of a vehicle, specifically to the use of mixed flow or centrifugal blowers to reduce the amount of infrared radiation being emitted from the engine exhaust. A blower and mixer are used to cool the exhaust gas from an aircraft engine. The blower and mixer use a tertiary exhaust duct to swirl cool air from an engine particle separator (EPS) and/or oil cooler, for example, with the hot engine exhaust gas. Existing blowers in the EPS or oil cooler may be used to motivate air flow so that a unique or dedicated blower is not required. In addition to reducing exposure to hostile forces, other benefits of cooling the exhaust gas include greatly reduced ground-impingement temperatures and safer personnel working zones because the hot plume is mostly eliminated.

### BACKGROUND

Vehicles that are involved in military operations need to reduce their exposure to opposing forces, including, for example, minimizing detection by visual, active and passive radar, and/or infrared means. Avoiding detection is especially critical for aircraft, including fixed-wing, rotorcraft, and tiltrotor aircraft, that may be targeted by enemy air and ground forces using any of the above detection means. In addition, lowering the exhaust gas temperature can extend the life of engine exhaust components in the immediate path of such gasses. Many methods have been developed to reduce the infrared signature of aircraft, such as using special exhaust ducting and shrouding to reduce the heat signature in engine exhaust and adding infrared-insulative and infrared-absorptive materials on the outer surface of the aircraft. Although these methods can be effective when properly employed, each of these methods has drawbacks, such as added weight, heating of the ducting or shrouding, and/or adverse aerodynamic characteristics.

### SUMMARY

Embodiments are directed to systems and methods for reducing the infrared signature of a vehicle, specifically to the use of mixed flow or centrifugal blowers to reduce the Exhaust Gas Temperature which also reduces the amount of infrared radiation being emitted from the engine exhaust. In one embodiment, a blower and simple mixer are used to cool the exhaust gas from an aircraft engine. The blower and mixer use a tertiary exhaust duct to swirl cool air from an engine particle separator (EPS) and/or oil cooler, for example, with the hot engine exhaust gas. Existing blowers in the EPS or oil cooler may be used to motivate air flow so that a unique or dedicated blower is not required. In addition to reducing exposure to hostile forces, other benefits of cooling the exhaust gas include greatly reduced ground-impingement temperatures and safer personnel working zones because the hot plume is mostly eliminated.

### BRIEF DESCRIPTION OF THE DRAWINGS

Having thus described the invention in general terms, reference will now be made to the accompanying drawings, which are not necessarily drawn to scale, and wherein:

FIG. 1 illustrates a tiltrotor aircraft in a helicopter mode wherein the proprotors are positioned substantially vertical for use with certain embodiments.

FIG. 2 illustrates the tiltrotor aircraft of FIG. 1 in an airplane mode wherein the proprotors are positioned substantially horizontal.

FIG. 3 illustrates an aircraft engine pylon according to an example embodiment.

FIG. 4 is a cross-section view of an exhaust area of an engine showing three different airflow streams are showing exiting the engine.

FIG. 5 is a cross-section view of the exhaust area shown in FIG. 4.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

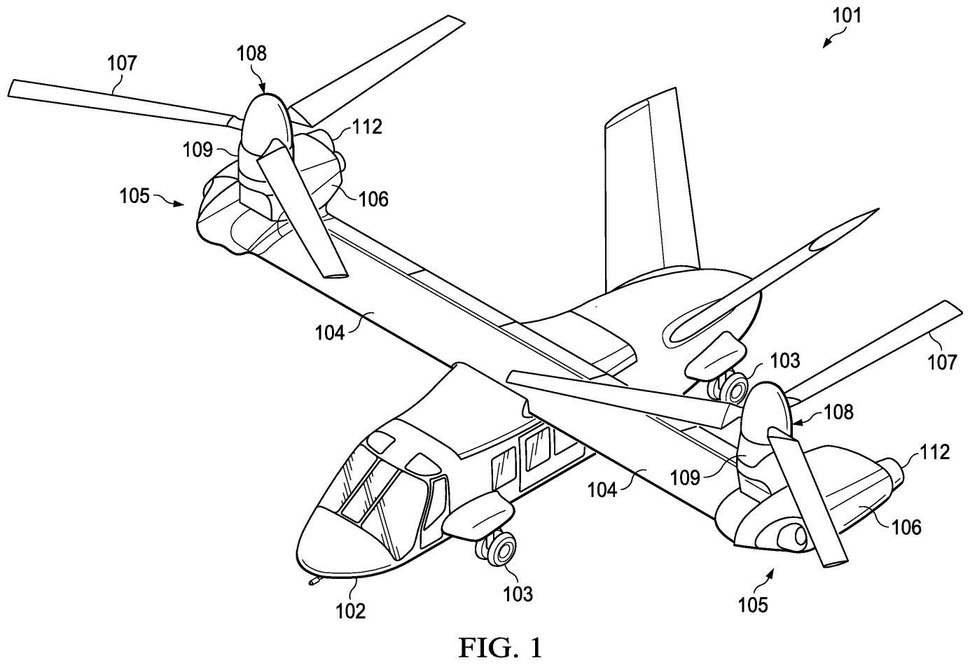

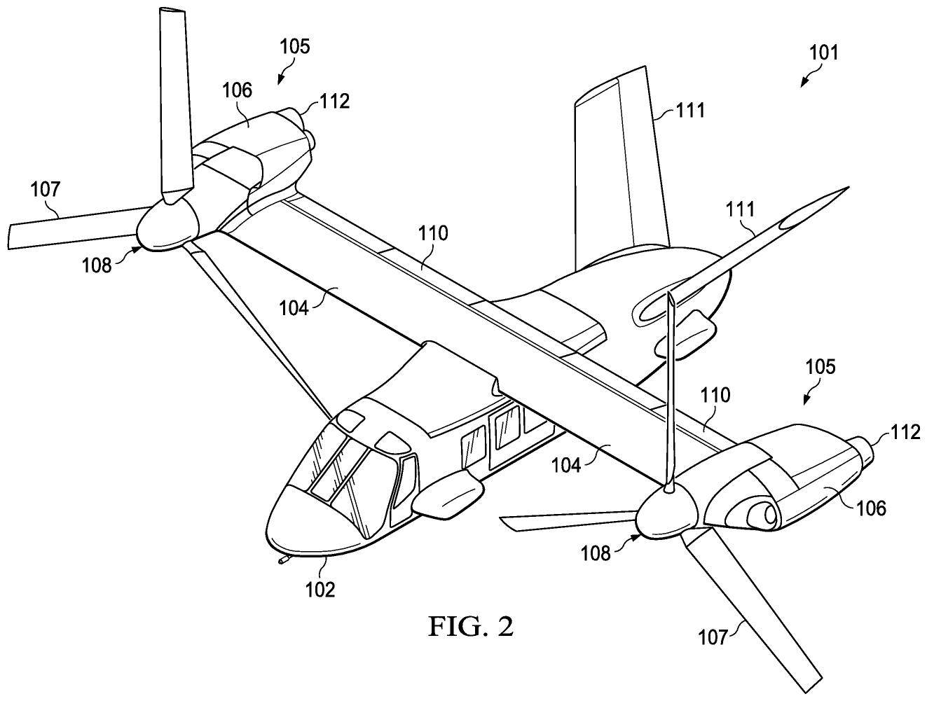

FIG. 1 illustrates a tiltrotor aircraft 101 in a helicopter mode wherein proprotors 107 are positioned substantially vertical to provide a lifting thrust. FIG. 2 illustrates tiltrotor aircraft 101 in an airplane mode wherein proprotors 107 are positioned substantially horizontal to provide a thrust for forward movement. The following discussion refers to the example embodiments shown in FIGS. 1 and 2. Tiltrotor aircraft 101 may include fuselage 102, landing gear 103, and wings 104. A propulsion system 105 is positioned on the ends of wings 104. Each propulsion system 105 includes an engine 106 and a proprotor 108 with a plurality of rotor blades 107. During operation, engines 106 typically maintain a constant rotational speed for their respective proprotors 107. The pitch of rotor blades 107 can be adjusted to selectively control thrust and lift of each propulsion system 105 on tiltrotor aircraft 101. The tiltrotor aircraft 101 includes controls, e.g., cyclic controllers and pedals, carried within a cockpit of fuselage 102, for causing movement of the aircraft 101 and for selectively controlling the pitch of each blade 107 to control the direction, thrust, and lift of tiltrotor aircraft 101. For example, during flight a pilot can manipulate a cyclic controller to change the pitch angle of rotor blades 107 and/or manipulate pedals to provide vertical, horizontal, and yaw flight movement.

Propulsion system 105 includes a pylon 109 that is configured to rotate along with other rotatable pylon structure to improve aerodynamic airflow. Moveable pylon 109 can be mechanically coupled to an actuator system used for moving the proprotors 107 between airplane mode and helicopter mode. During the airplane mode, vertical lift is primarily supplied by the airfoil profile of wings 104, while rotor blades 107 provide forward thrust. During the helicopter mode, vertical lift is primarily supplied by the thrust of rotor blades 107. It should be appreciated that tilt rotor aircraft 101 may be operated such that propulsion systems 105 are selectively positioned between airplane mode and helicopter mode, which can be referred to as a conversion mode. Control surfaces 110 on wing 104 are used to adjust the attitude of tiltrotor aircraft 101 around the pitch, roll, and yaw axes while in airplane or conversion mode. Additional stabilizers or control surfaces 111 may be required when tiltrotor aircraft 101 is in airplane mode. Control surfaces 110 and 111 may be, for example, ailerons, flaps, slats, spoilers, elevators, rudders, or ruddervators.

Propulsion system 105 for a tiltrotor aircraft 101 typically features a power train, drive shaft, hub, swashplate, and pitch links within pylon 109. The drive shaft and hub are mechanical components for transmitting torque and/or rotation from the engine 106 to the rotor blades 107. The power train may include a variety of components, including a transmission and differentials. In operation, the drive shaft receives torque or rotational energy from engine 106 and rotates the hub, which causes blades 107 to rotate about the drive shaft. A swashplate translates flight control input into motion of blades 107. Rotor blades 107 are usually spinning when tiltrotor aircraft 101 is in flight, and the swashplate transmits flight control input from the non-rotating fuselage 102 to the hub, blades 107, and/or components coupling the hub to blades 107 (e.g., grips and pitch horns).

FIGS. 1 and 2 show a propulsion system 105 in which engine 106 remains in a fixed position while proprotor 108, rotor blades 107, and pylon 109 rotate between the helicopter, conversion, and airplane modes. The exhaust gases from engine 106 are expelled through exhaust nozzle or tailpipe 112 in a rearward direction in all aircraft configurations. In other embodiments, the entire propulsion system 105, including engine 106, may rotate relative to wing 104. In such an embodiment, the exhaust nozzle 112 would also rotate with engine 106 so that exhaust gases are expelled in a rearward direction during aircraft mode, downward in helicopter mode, and in both directions during conversion mode.

The infrared radiation generated by engine exhaust is widely used by military forces to detect and track aircraft. Infrared homing (e.g., “heat seeking”) can be used in passive weapon guidance systems, such as passive missile systems that use infrared emissions from a target aircraft to track and intercept it. Accordingly, it is important for military aircraft or aircraft exposed to hostile forces to minimize the infrared radiation generated by engine exhaust. Since the engine exhaust heat is the source of an aircraft's infrared radiation, it is necessary to lower the exhaust gas temperature to reduce the infrared radiation. In one embodiment, a blower and simple mixer are used to greatly cool the engine exhaust gas from an aircraft engine.

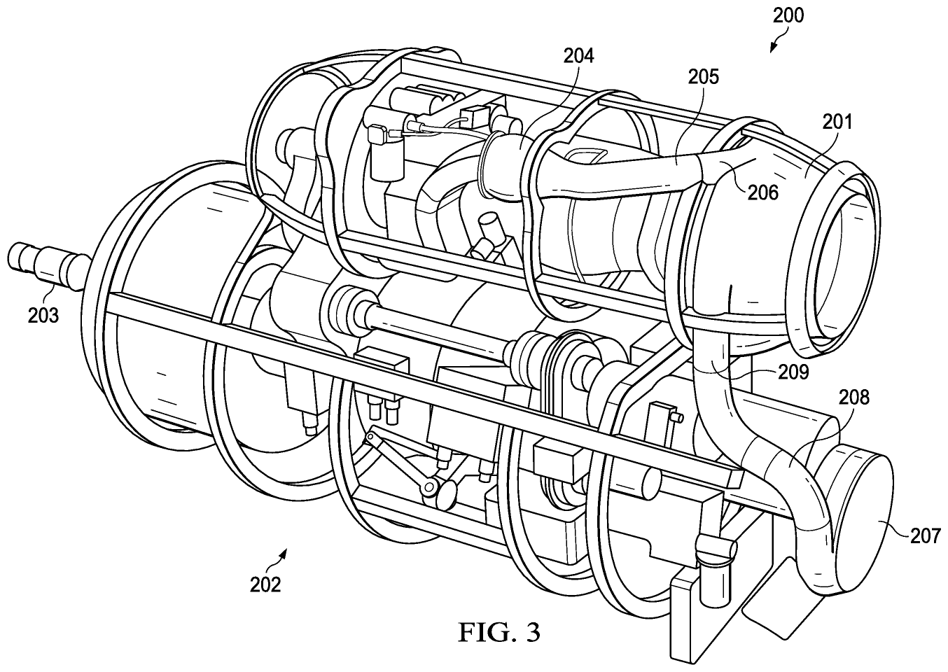

FIG. 3 illustrates an aircraft engine pylon 200 according to an example embodiment. Engine 200 is a gas turbine engine comprising compressor, combustion, and turbine sections. Inlet air is taken into the compressor and compressed to a high pressure. The compressed air is mixed with fuel and ignited, which produces high-pressure, high-velocity gas. This gas is used to turn the turbine section, which then powers the compressor section via a coupling shaft. After passing through the turbine section, the gas is expelled through an exhaust nozzle 201. The coupling shaft also drives a nacelle accessory gearbox 202, which in turn drives accessories such as generators, hydraulic pumps, oil pumps, and the like. In a tiltrotor aircraft, the nacelle accessory gearbox 202 also has a drive-shaft 203 that powers a main rotor gearbox (not shown). The main rotor gearbox drives the rotor system and turns the rotor blades to provide lift.

Engine 200 may have an engine particle separator (EPS) that is used to remove contaminant particles before they enter the gas turbine engine. The EPS filters particulates, such as dust and sand, from the inlet airflow to produce a substantially filtered inlet air to engine 200. An EPS blower 204 is used to blow the bypass air from the EPS through EPS duct 205 to exhaust nozzle 201. Because the EPS bypass air in duct 205 does not pass through the compression and combustion sections of engine 200, it has a much lower temperature than the engine exhaust. The EPS bypass air can be mixed with the engine exhaust to reduce the overall temperature of the air leaving exhaust nozzle 201. EPS bypass duct connection 206 on exhaust nozzle 201 is configured to introduce the EPS bypass air tangentially into the engine exhaust airflow. The EPS bypass air enters at approximately 90 degrees to the engine exhaust airflow and creates a combined flow swirling effect in exhaust nozzle 201.

Nacelle accessory gearbox 202 may include an engine oil cooler with a blower fan 207 that is used to cool the oil for engine 200. The exhaust from oil cooler blower fan 207 also has a much lower temperature than the engine exhaust. Therefore, the exhaust from oil cooler blower fan 207 can also be mixed with the engine exhaust to reduce the overall temperature of the air leaving exhaust nozzle 201. The exhaust from blower fan 207 is routed to exhaust nozzle 201 using duct 208. A shutoff valve may be incorporated into duct 208 to prevent hot gas backflow in the event of blower failure. Oil cooler blower duct connection 209 on exhaust nozzle 201 is configured to introduce the oil cooler blower fan air tangentially into the engine exhaust airflow. Like the EPS bypass air, the oil cooler fan air enters at approximately 90 degrees to the engine exhaust airflow, creates a centrifugal blower effect in exhaust nozzle 201.

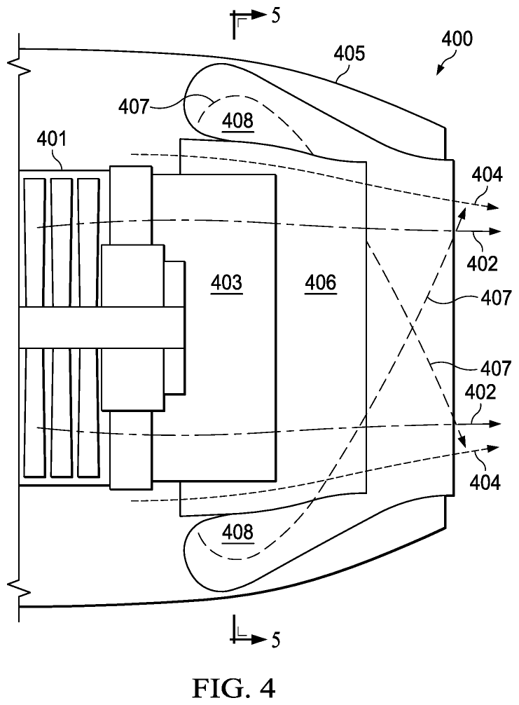

FIG. 4 is a cross-section view of an exhaust area 400 of an engine showing three different airflow streams are showing exiting the engine according to an example embodiment. The primary exhaust airflow 402 comprises hot gas from the engine and exits turbine section 401 through a tailpipe section 403. A secondary exhaust airflow 404 comprises engine bay ejected flow that passes along the outside of the engine and within an engine shroud 405. The secondary exhaust airflow 404 may originate, for example, from vents in an engine bay, from a low-pressure compressor section, from a bypass duct, or the like. The secondary exhaust airflow 404 joins with the primary exhaust airflow 402 in exhaust nozzle area 406. The engine bay ejector flow 404 is roughly parallel to the primary exhaust airflow 402. Since engine bay ejector flow 404 and primary exhaust airflow 402 create a laminar flow with no disruption between the layers, there is little mixing and, therefore, engine bay ejector flow 404 has minimal cooling effect on the exhaust gas temperature.

Existing engine designs provide primary exhaust airflow 402 and engine bay ejector flow 404 and may include guide vanes, fins, or ducts that are used to swirl or mix the primary exhaust airflow 402 and engine bay ejector flow 404. Instead of, or in addition to, using these mechanical means to mix the exhaust airflow, the exhaust shown in FIG. 4 uses a tertiary airflow 407 to swirl relatively cool air into the exhaust. The tertiary airflow 407 originates from one or more sources external to the engine itself, such as the oil cooler blower and/or EPS blower. For example, the primary exhaust airflow temperature may be approximately 1100° F. while an oil blower exhaust may be only 215° F. Tertiary airflow 407 is introduced at approximately 90 degrees relative to the primary exhaust airflow 402 in a mixing duct 408. By entering the exhaust area 400 off-axis, the tertiary airflow 407 is forced to swirl and mix with primary exhaust airflow 402 and engine bay ejector flow 404 thereby creating a mixed exhaust airflow having a lower net temperature. The resulting lowered temperature will be dependent on the mass flow and temperature of the tertiary airflow 407. It will be understood that in other embodiments, the tertiary airflow 407 may be introduced at angles other than 90 degrees relative to the primary exhaust airflow 402, such as 45-135 degrees off-axis to the primary exhaust airflow 402 to induce a swirling effect in mixing duct 408.

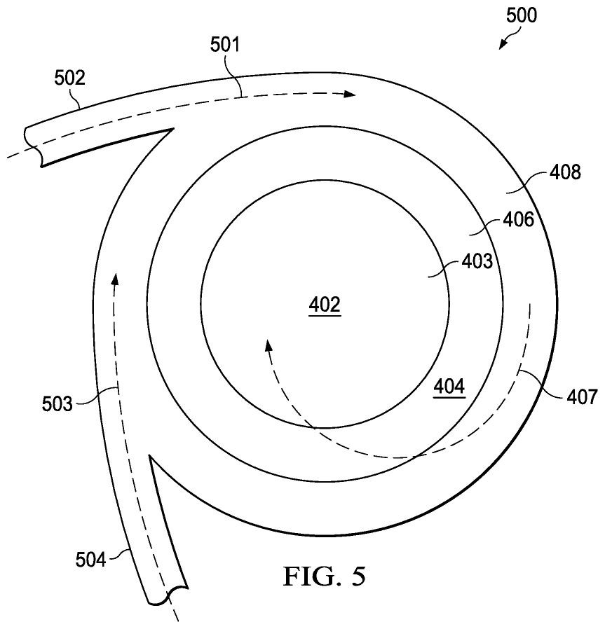

FIG. 5 is a cross-section view 500 of exhaust area 400. Primary exhaust airflow 402 exits through a tailpipe section 403. Secondary exhaust airflow 404 joins with primary exhaust airflow 402 in exhaust nozzle area 406. The primary exhaust airflow 402 and secondary exhaust airflow 404 are then mixed with a swirling tertiary airflow 407 is introduced at approximately 90 degrees relative to the primary exhaust airflow 402 by a mixing duct 408. The tertiary airflow 407 may come from any source, such as an oil cooler blower and/or EPS blower and/or other centrifugal blower. In one embodiment, air 501 from an EPS blower is introduced into the mixing duct 408 via duct 502 at approximately 90 degrees to the primary exhaust airflow 402 and secondary exhaust airflow 404. Additionally, or alternatively, air 503 from an oil cooler blower is introduced into the mixing duct 408 via duct 504 at approximately 90 degrees to the primary exhaust airflow 402 and secondary exhaust airflow 404. Because the tertiary airflow 407, such as EPS blower air 501 or oil cooler blower air 503, is introduced off-axis into exhaust airflows 402 and 404, a turbulent mixing of the airflows occurs, which has the effect of lowering the overall temperature exhaust gas mixture.

Embodiments of the present disclosure are not limited to any particular setting or application, and embodiments can be used with a rotor system in any setting or application such as with other aircraft, vehicles, or equipment. It will be understood that tiltrotor aircraft 101 is used merely for illustration purposes and that any aircraft, including fixed wing, rotorcraft, commercial, military, or civilian aircraft may use an engine-exhaust suppressor system as disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A system for mixing airflows in an engine exhaust, comprising:
a turbine section of the engine configured to create a primary exhaust airflow during operation;
an exhaust section coupled to the turbine section and configured to pass the primary exhaust airflow; and
a mixing section in the exhaust section, the mixing section configured to receive airflow from an engine accessory component and to mix the accessory component airflow with the primary exhaust airflow.

2. The system of claim 1, wherein the accessory component airflow enters the mixing section at an angle relative to the primary exhaust airflow to create a swirling effect in the mixing section to mix the primary exhaust airflow and the accessory component airflow.

3. The system of claim 1, wherein the mixing section further receives engine bay ejector airflow that passes along an outside of the engine, and wherein the mixing section mixes the engine bay ejector flow with the primary exhaust airflow and the accessory component airflow.

4. The system of claim 1, wherein the accessory component is a centrifugal blower.

5. The system of claim 1, wherein the accessory component is an oil cooler blower.

6. The system of claim 1, wherein the accessory component is an engine particle separator (EPS).

7. The system of claim 1, wherein the airflow from the engine accessory component is introduced into the mixing duct at approximately 90 degrees relative to the primary exhaust airflow.

8. The system of claim 1, further comprising:
a shutoff valve between the mixing section and the engine accessory component, wherein the shutoff value is configured to prevent hot gas backflow to the engine accessory component.

9. The system of claim 1, wherein the engine is configured to move between a horizontal position and a vertical position during operation.

10. A tiltrotor aircraft, comprising:
a fuselage;
a wing member;
a power train coupled to the wing member and comprising a power source and a drive shaft in mechanical communication with the power source, wherein the power source comprises:
an engine having a turbine section configured to create a primary exhaust airflow during operation;
an exhaust section coupled to the turbine section and configured to pass the primary exhaust airflow; and
a mixing section in the exhaust section, the mixing section configured to receive airflow from an engine accessory component and to mix the accessory component airflow with the primary exhaust airflow; and
a rotor system in mechanical communication with the drive shaft, at least part of the rotor system being tiltable between a helicopter mode position and an airplane mode position.

11. The tiltrotor aircraft of claim 10, wherein the accessory component airflow enters the mixing section at an angle relative to the primary exhaust airflow to create a swirling effect in the mixing section to mix the primary exhaust airflow and the accessory component airflow.

12. The tiltrotor aircraft of claim 10, wherein the mixing section further receives engine bay ejector airflow that passes along an outside of the engine, and wherein the mixing section mixes the engine bay ejector flow with the primary exhaust airflow and the accessory component airflow.

13. The tiltrotor aircraft of claim 10, wherein the accessory component is a centrifugal blower.

14. The tiltrotor aircraft of claim 10, wherein the accessory component is an oil cooler blower.

15. The tiltrotor aircraft of claim 10, wherein the accessory component is an engine particle separator (EPS).

16. The tiltrotor aircraft of claim 10, wherein the airflow from the engine accessory component is introduced into the mixing duct at approximately 90 degrees relative to the primary exhaust airflow.

17. The tiltrotor aircraft of claim 10, wherein the engine is configured to move between a horizontal position and a vertical position during operation.

18. The tiltrotor aircraft of claim 10, further comprising:
a shutoff valve between the mixing section and the engine accessory component, wherein the shutoff value is configured to prevent hot gas backflow to the engine accessory component.
